(19) United States
(12) Patent Application Publication
(10) Pub. No.: US 2010/0064581 A1
(43) Pub. Date: Mar. 18, 2010

(54) Automated plant support system

(76) Inventor: Dallas G. Johnson, Council Bluffs, IA (US)

Correspondence Address: THOMTE LAW OFFICE, L.L.C., 2120 S. 72ND STREET, SUITE 1111, OMAHA, NE, 68124, US

(21) Appl. No.: 12/283,564

(22) Filed: Sep. 12, 2008

(51) Int. Cl. A01G 25/16; A01G 29/00

(52) U.S. Cl. 47/79; 47/48.5

(57) ABSTRACT

An automated plant watering system including an outer container, an inner container spaced from the interior of the outer container to define a water reservoir therebetween. A submersible pump is in communication with the water reservoir and is controlled by a programmable controller so that water will be delivered to growing plants, seeds, etc., not only at predetermined times but upon the soil moisture [symbol] plant soil dropping to a predetermined level as sensed by a moisture sensor or probe positioned in the soil and operatively connected to the programmable computer. The system is operated by a DC battery pack.

### BACKGROUND OF THE INVENTION

1. Field of the Invention

This invention relates to a plant support system and more particularly to an automated plant support system which includes a soil moisture sensor operatively connected to a programmable controller which will automatically supply water to the plant when the soil moisture reaches a predetermined level. Even more particularly, the programmable controller will periodically deliver water to the plant at pre-set times.

2. Description of the Related Art

Many types of plant support systems have been previously supplied to supply water to a plant at predetermined times. However, it is not believed that any of the prior art systems incorporate a programmable controller or processor which will deliver or supply water to a plant or plants not only at pre-set times but also which will supply water to the plant or plants when the soil moisture of the plant drops to a predetermined level. It is believed that the prior art systems require much more personal attention to ensure that the plants are watered sufficiently with that shortcoming being extremely burdensome when several hundred or several thousands of plants are being supported or managed.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

An automated plant support system is described which includes an outer container having a bottom wall, upstanding side walls and an open upper end. An inner container is positioned within the outer container and has a bottom wall, upstanding side walls, and an open upper end. The inner container is adapted to have at least one and normally several plants positioned therein. The bottom wall and the side walls of the inner container are spaced from the bottom wall and the side walls of the outer container to define a water reservoir therebetween.

A plant support system is positioned between the side walls of the inner and outer containers and includes an elongated hollow tube, having upper and lower ends, positioned between the side walls of the inner and outer containers. The lower end of the tube is positioned adjacent the bottom wall of the outer container. The lower end of the tube has at least one water inlet opening formed therein to permit water in the water reservoir to enter the interior of the tube. The plant support system includes a DC battery-powered submersible pump positioned in the tube adjacent the lower end thereof. The pump has a water level float switch operatively associated therewith. The plant support system also includes a DC battery and a programmable controller which is operatively connected to the submersible pump to control the operation thereof.

The plant support system also includes a water distribution line which is in fluid communication with the discharge side of the submersible pump and which extends to an area adjacent the plant or plants. The plant support system also includes a soil moisture sensor or probe which is connected to the programmable controller and which is adapted to be placed in the soil of the plant or plants whereby the soil moisture is monitored by the programmable controller which will energize the submersible pump to supply water to the plant by way of the water distribution line when the soil moisture drops to a predetermined level. The programmable controller is also programmed so as to be able to deliver or supply water to the plant or plants at predetermined times. The plant support system may also include an optional fertilizer reservoir and a pump associated therewith to inject fertilizer into the water distribution line at predetermined times.

It is therefore a principal object of the invention to provide an improved automated plant support system. A further object of the invention is to provide an automated plant support system which is controlled by a programmable controller.

Still another object of the invention is to provide an automated plant support system which not only delivers water to plants or plants at predetermined times but which also will deliver water to the plant or plants when the moisture in the soil adjacent the plants drops to a predetermined level.

Still another object of the invention is to provide a plant support system including spaced-apart inner and outer containers which define a water reservoir therebetween with a submersible pump being in fluid communication with the water reservoir to pump water to the plant or plants as controlled by the programmable controller.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the automated plant support system of this invention with a portion of the side walls of the outer container being cut away to more fully illustrate the invention;

FIG. 2 is a perspective view of the portion of the automated plant support system with portions thereof cut away to more fully illustrate the invention;

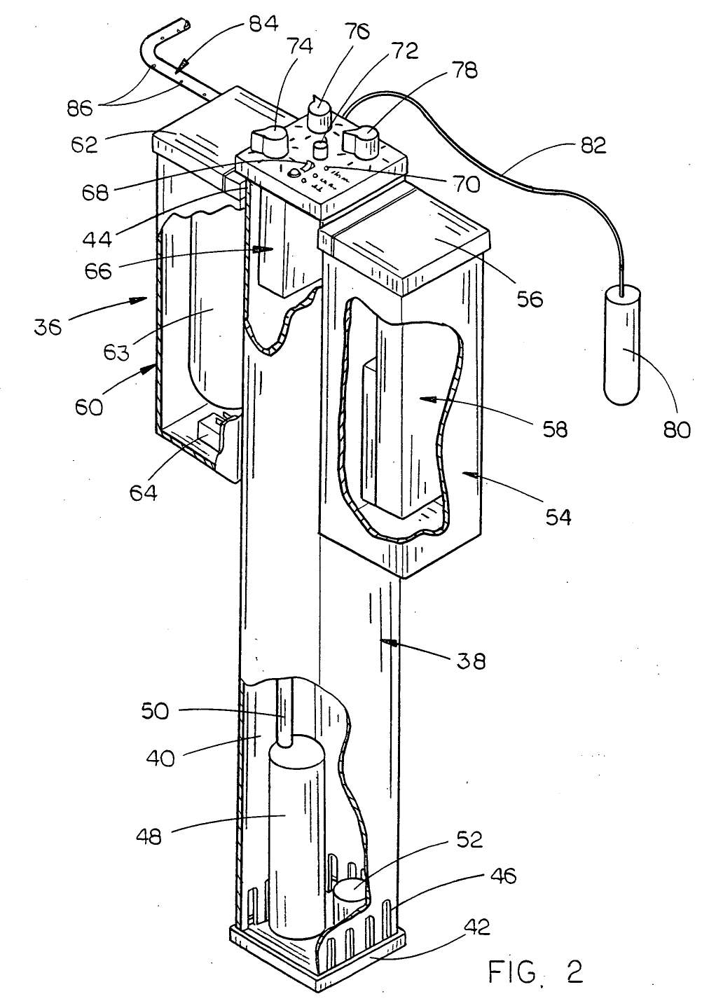

FIG. 3 is a partial sectional view of the system of this invention; and

FIG. 4 is a perspective view of a modified plant support system which includes solar panels to recharge the DC battery of the system.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The automated plant watering system of this invention is referred to generally by the reference numeral 10. System 10 includes an outer container 12 having a bottom 14, and upstanding walls 16. Preferably, the outer container 12 is supported on pedestals or supports 18. It is also preferred that the outer container 12 be insulated to protect the interior components of the system from excessive heat or the like. The exterior surface of the container 12 should also have an aesthetic appearance such as exposed rock, etc. The outer container 12 may be round, square or rectangular if so desired.

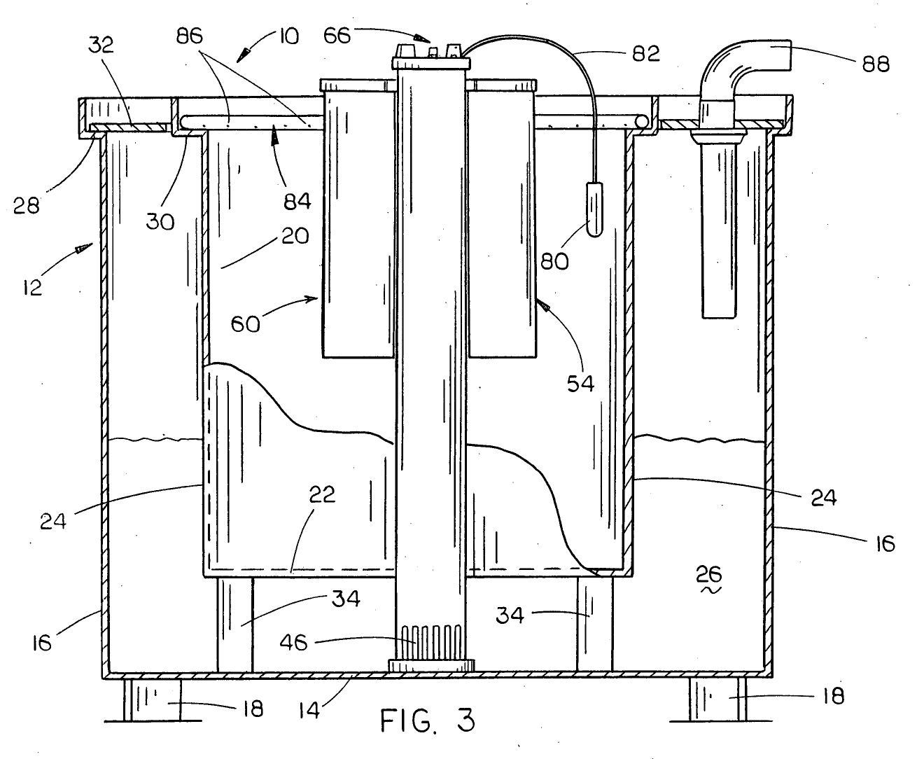

The numeral 20 refers to an inner container having a bottom 22 and upstanding sidewalls 24. As seen in FIG. 3, bottom wall 22 of inner container 20 is spaced above bottom 14 of outer container 12 and the side walls 24 of inner container 20 are spaced inwardly of side wall 16 of outer container 12 to define a reservoir 26 therebetween. As seen in FIG. 3, the side walls 16 of outer container 12 have a shoulder or ledge 28 extending outwardly therefrom. As also seen in FIG. 3, side walls 24 of inner container 20 have a ledge or shoulder 30 extending outwardly therefrom. The ledges 28 and 30 provide a means for supporting a cover 32 extending therearound to enclose the upper end of the water reservoir 26. The bottom 22 of inner container 20 is preferably supported by legs 34.

The numeral 36 refers generally to the plant support system of this invention which is positioned between the inner and outer containers. The system 36 includes an elongated upstanding hollow tube 38 having an interior 40, a lower end 42 and an upper end 44. The lower end of tube 38 has a plurality of water inlet openings 46 formed therein to permit water from the water reservoir 26 to enter the interior 40 of the tube 38 at the lower end thereof. A DC battery-powered submersible pump 48 is positioned in the lower interior of tube 38 and has a discharge line 50 extending upwardly therefrom. The lower end of submersible pump 48 is in fluid communication with the water in the interior of the tube 38 adjacent the lower end thereof. The numeral 52 refers to a water level float switch of conventional design which deactivates pump 48 upon the water level in the water reservoir 26 dropping to a predetermined level but which will permit the pump 48 to be energized, through the programmable controller to be described hereinafter, when the water in the reservoir 26 is sufficient to permit the pump 48 to function.

The numeral 54 refers to a housing which is secured to the upper end of tube 38 at one side thereof. Cover 56 is utilized to selectively close the upper end of the housing 54. A 12-volt DC battery pack 58 is positioned within the housing 54.

A housing 60 is also secured to the upper end of the tube 38 at one side thereof and has its upper end selectively closed by a cover or lid 62. Housing 60 is optional since it contains a fertilizer reservoir 63 and a DC diaphragm fertilizer pump 64. The ability to pump fertilizer into the water distribution line, to be described hereinafter, would normally not be used but is an optional feature.

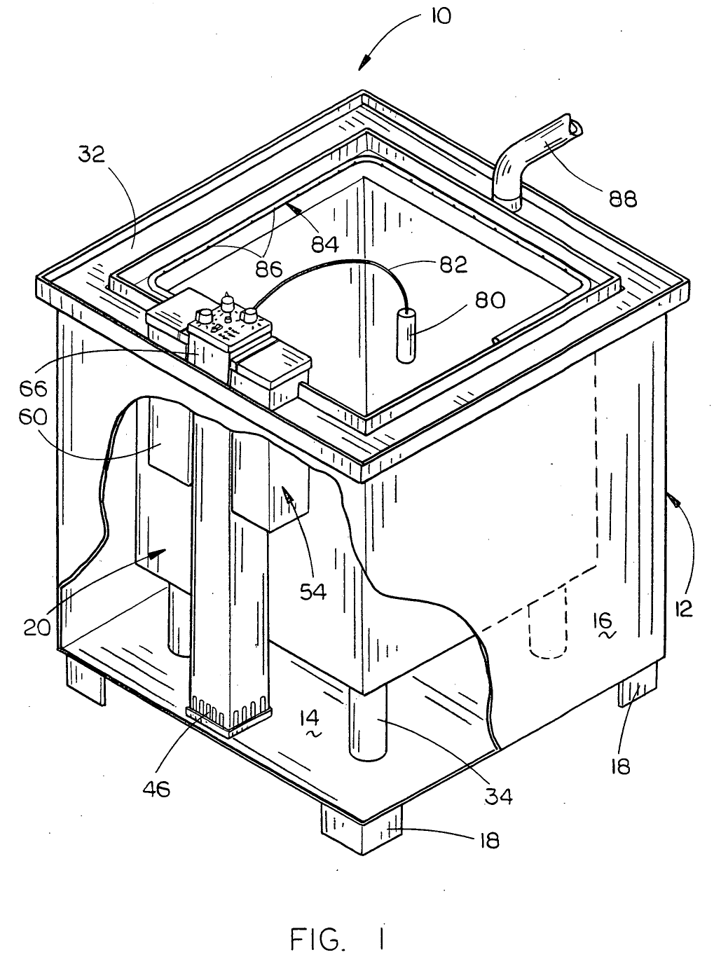

The numeral 66 refers to a programmable controller which is operatively electrically connected to the battery pack 58 and which is operatively connected to the pump 48 and float 52. Programmable controller 66 includes an on-off switch 68, LED indicator lights 70, a system fuse 72, a watering frequency control knob 74, soil moisture dial or knob 76 and an optional fertilizer frequency knob or dial 78. The numeral 80 refers to a conventional soil moisture probe which is connected to the controller circuitry by lead 82. The numeral 84 refers to a water distribution line having a plurality of spaced-apart discharge openings 86 provided along the length thereof. As seen in FIG. 1, the water distribution line 84 extends around the upper end of the inner container 20. The water distribution line 84 is operatively connected to the controller 66 and the pump 48 in conventional fashion. A water inlet pipe or line 88 extends through the cover 32 to supply water to the water reservoir 26. Pipe 88 is connected to a source of water under pressure. It is preferred that the size of the reservoir 26 be such that it can hold a 30-day supply of water.

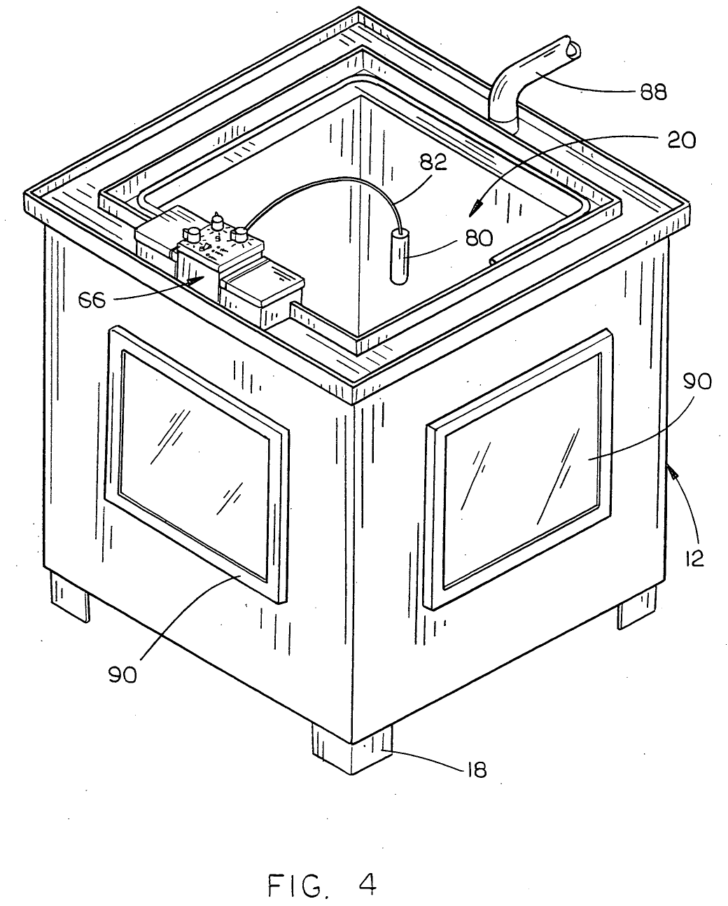

FIG. 4 illustrates a modified form of the system 10 with the only difference being is that solar panels 90 are secured to the exterior surface of the outer container 12 to be able to recharge the 12-volt battery pack 58 in conventional fashion.

In use, a plant or plants will be positioned in containers or trays which will be positioned within the interior of inner container 20. The soil probe 80 will be placed into contact with the soil surrounding the plant or plants. The water reservoir 26 will be filled with water to a predetermined level by way of the inlet pipe 88. The watering frequency dial 74 will then be set so that the programmer 66 will cause water to be supplied to the plant or plants by way of the water distribution line 84. If the optional fertilizer system is to be used, the fertilizer frequency dial or knob 78 will also be preset. The soil moisture dial 76 will also be set so that water will be supplied to the plant or plants when the soil sensor or probe 80 senses that the moisture level in the soil surrounding the plant or plants has dropped to a predetermined level. At that time, the switch 68 will be moved to the “on” position. The programmable controller 66 will then cause water to be supplied to the plants at a predetermined frequency and will also cause water to be distributed to the plants when the soil moisture has dropped to a predetermined level. The solar panels, if used, will recharge the 12-volt battery pack 58 in conventional fashion.

The support system of this invention enables plants to be supported with water without constant personal attention thereto. Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. An automated plant watering system comprising:
an outer container having a bottom wall, upstanding side walls and an open upper end;
an inner container positioned within said outer container having a bottom wall, upstanding side walls, and an open upper end;
said inner container adapted to have at least one plant positioned therein;
said bottom wall and said side walls of said inner container being spaced from said bottom wall and said side walls of said outer container to define a water reservoir therebetween;
a plant support system positioned between said side walls of said inner and outer containers;
said plant support system including an elongated hollow tube, having upper and lower ends, positioned between said side walls of said inner and outer containers;
said lower end of said tube being positioned adjacent said bottom wall of said outer container;
said lower end of said tube having at least one water inlet opening formed therein to permit water in said water reservoir to enter the interior of said tube;
said plant support system including a DC battery-powered submersible pump positioned in said tube adjacent said lower end thereof;
said pump having a water level float switch operatively associated therewith;
said plant support system including a DC battery and a programmable controller which is operatively connected to said submersible pump to control the operation thereof;
said plant support systems including a water distribution line which is in fluid communication with the discharge side of said pump and the plant;
said plant support system also including a soil moisture sensor which is connected to said programmable controller and which is adapted to be placed in the soil of the plant whereby the soil moisture is monitored by said programmable controller which will energize said submersible pump to supply water to the plant by way of said water distribution line when the soil moisture reaches a predetermined level.

2. The automated plant watering system of claim 1 wherein said programmable controller includes means for controlling the frequency of plant watering.

3. The automated plant watering system of claim 1 wherein said programmable controller includes means for adjusting the level of soil moisture required to energize said submersible pump.

4. The automated plant watering system of claim 1 wherein said DC battery comprises a battery pack.

5. The automated plant watering system of claim 4 wherein said battery pack is positioned between the side walls of said outer and inner containers.

6. The automated plant watering system of claim 1 wherein said water reservoir is in communication with a source of water for replenishing said water reservoir.

7. The automated plant watering system of claim 1 wherein said plant support system also includes means for automatically applying fertilizer to the plant.
